(19) United States
(12) Patent Application Publication
(10) Pub. No.: US 2017/0248305 A1
(43) Pub. Date: Aug. 31, 2017

(54) SYSTEM FOR GENERATING SUPERHEATED STEAM USING HYDROGEN PEROXIDE

(71) Applicants: Juan Jesus AVALOS-GARCIA, Mexico City (MX); Maria Yokasta VON-JESS-NUNEZ, Mexico City (MX)

(72) Inventors: Juan Jesus AVALOS-GARCIA, Mexico City (MX); Maria Yokasta VON-JESS-NUNEZ, Mexico City (MX)

(21) Appl. No.: 15/320,254

(22) PCT Filed: Jun. 22, 2015
(86) PCT No.: PCT/IB2015/001023

§ 371 Date: Dec. 19, 2016

Related U.S. Application Data
(60) Provisional application No. 62/014,748, filed on Jun. 20, 2014.

(51) Int. Cl. F22G 1/14; E21B 37/00; E21B 43/24; C01B 5/00; B01J 7/02

(52) U.S. Cl. CPC F22G 1/14; C01B 5/00; B01J 7/02; E21B 43/24; E21B 43/2405; E21B 37/00

(57) ABSTRACT

The invention relates to a system for generating superheated steam using hydrogen peroxide, formed by: a container for storing hydrogen peroxide, which stores a solution of peroxide that is used during the reaction to generate superheated steam; a hydrogen peroxide discharge pump connected to a first connecting duct, said discharge pump being used to pump the hydrogen peroxide solution to a reaction container via a second connecting duct; and a steam generating reaction container or reactor, in which the reaction takes place and the superheated steam is generated, said reaction container or reactor receiving the hydrogen peroxide solution in order for the reaction to take place and the superheated steam to be generated and subsequently conveyed through a nozzle and an outlet duct towards installations that are to undergo cleaning and/or stimulation.

### FIELD OF THE INVENTION

The present invention relates to systems employing thermal means for secondary oil recovery, well and oil reservoir stimulation, equipment cleaning and devices for the production and/or refining of oil, cleaning of lines and heads of conduction and collection of hydrocarbons, as well as any other equipment that may be cleaned by thermal means due to the accumulation of solids from hydrocarbons (paraffins and asphaltenes), or else, by accumulation of salts, organic and inorganic solids, in both, onshore and offshore facilities; and more particularly relates to a system for generating superheated steam using hydrogen peroxide to generate it.

### BACKGROUND OF THE INVENTION

Within the Oil Industry, the oil extraction from a reservoir is a complex procedure that requires specialized machinery to be carried out and whose complexity degree depends on the oil characteristics found in the reservoir. Currently, there are three types of oil extraction or recovery: primary, secondary, and tertiary.

In primary recovery, the fluid pressure inside the reservoir is enough to force the natural output of oil through the well. This type of extraction is applied for oil of very low API gravity, however this type of oil (light crudes) is associated with problems due to the type of paraffins it contains.

The key factors for successful primary recovery are: reservoir energy (reservoir pressure and rock-fluid system expansion); and, the oil mobility (permeability/viscosity of the oil). An example of successful primary recovery is the Boscán giant field in the western region of Venezuela. This field has produced more than 1300 million barrels of oil of 10° API during more than 50 years of operation.

The secondary or improved recovery is required once the internal pressure of the reservoir has dropped enough so that the oil does not naturally output. It is demonstrated at a world level that during the primary oil extraction, only a maximum of 20% of the oil reserve is obtained, leaving up to 80% of the oil for extraction by secondary recovery.

The improved or secondary recovery techniques significantly increase final recovery, so this method can be used when primary production is no longer feasible. However, the improved recovery involves investments and operational expenses much higher than those required by the primary production, since other types of techniques than the traditional ones are involved, such as water injection or steam injection.

The steam injection process is one of the dominant techniques in improved recovery for heavy oil extraction. It includes the steam injection at high pressure and temperature, to compensate the loss of pressure inside the reservoir and to give mobility to the fluids, to later extract the oil through pumping equipment. The steam injection increases the mobility of fluids inside the reservoir, when the viscosity of the oil is modified with the increase in temperature, so this application is ideal for oils lower than 22° API and high viscosities. When mobility of fluids increases, the productivity of the wells increases, generating higher profitability in sand reservoirs with intercalated clays containing high viscosity oils.

The thermal methods basically consist in increasing the temperature of the reservoir, since the heavy oils show a great decrease of their viscosity with an increase in the temperature, besides the removal of obstructions by the presence of paraffins or asphaltenes; on the other hand, light oils of higher grade API, although they do not have problems of mobility, present higher plugging by high presence of paraffins. The melting temperature of the paraffin is from 64° F. (18° C.) to 211° F. (95° C.), which range should be used to define the temperature at which the thermal means to remove solid reservoirs with greater efficiency should be used. Such systems must always operate above this point of fusion.

Based on the above, the main obstacle to exploiting a heavy oil reservoir is the high viscosity of the oil, but this can be reduced, by thermal methods, and in the case of light oils, the thermal means will promote the solids dissolution, obtaining in both cases considerable production increases, as well as recovery of high percentages in efficiency of the equipment operation, such as heat exchangers, rigs, lines, separators, pumps, etc.

Once it is no longer possible to extract oil by secondary recovery, it is required to use techniques to inject chemical agents, miscible, microbial agents, or use electric and/or vibrational methods, among others, these methods are known as tertiary recovery.

When using chemical agents, some of these not only damage the extraction equipment, but it has been proven that the oil, must be cleaned prior to refining to remove such chemicals, greatly increasing the cost of production.

There are four key factors for an effective and efficient recovery operation improved with the steam application:
Efficient steam generation with good quality.
Effective steam distribution at the surface and in subsoil.
Effective production monitoring.
Effective monitoring of heat and saturation in the reservoir.

For the steam injection process, steam generated from the water heating is generally used, which must be pretreated (distilled water). The commonly used equipment generates steam by treated water heating, by fossil fuels burning in boilers until reaching a steam quality of 70% to 80% maximum.

The installation of these equipment requires a great amount of logistic efforts, as well as the construction of a lines network for the injection in the wells.

Likewise, during the steam transport process, there is a large loss of heat energy throughout the system, which makes this process very costly, low efficiency and difficult to reach remote locations, sinuous terrain, or offshore applications, being only used as a secondary stimulation and recovery system, but not as a facility cleaning treatment. The continuous injection of conventional steam in all cases, involves additional associated high expenses that involve having to finish wells completely designed to withstand high temperature (thermal wells).

To overcome some of the drawbacks, today we can find in the prior art, various steam injection systems for oil reservoirs, which produce steam from hydrogen peroxide without reaching superheated vapor conditions.

An example of the steam injection systems from hydrogen peroxide of the prior art can be found in U.S. Pat. No. 4,456,069, which discloses an apparatus which is located outside the extraction well and which by means of the gas injection into the well, raises the pressure and temperature inside the reservoir to stimulate the extraction through the effects of thermal stress and high pressure gas flow.

Said apparatus includes a gas generator, wherein a reactant (hydrogen peroxide) is decomposed by a catalyst to form high temperature decomposition gases, such as steam and oxygen, and an air compressor for injecting compressed air into the well to assist in increasing the pressure within the reservoir, thereby increasing the permeability of said reservoir and subsequent flow of reservoir fluids into the well after stimulation. This is carry out by a borehole or injector well.

The equipment above described has the drawback that it requires special adaptations to operate in any type of well (terrestrial or marine), where such adaptations comprise having to enable a borehole or injector well; also, its objective is the generation of hot gases and the air compressors for re-pressuring the wells.

Another example of the prior art systems and equipment is found in U.S. Pat. No. 8,020,614 B2, which discloses an apparatus including a decomposition engine having an inlet manifold extending centrally within a housing and having means for the passage of hydrogen peroxide through the wall of the manifold through a catalyst. The decomposition products produced are directed through a venturi outlet tube and passed through a piping system that allows for selective ventilation or the introduction of the products into a facility to be cleaned. The apparatus includes control means which are coupled to the engine and valves to permit selective adjustment of the temperature and or pressure of the decomposition products as well as the introduction and deflection of the mixture in the facility.

In U.S. Pat. No. 8,020,614 B2, the specific use of the invention for the treatment of oil wells is not mentioned, although in the background there is mentioned the counterpressure exerted by the plugging in discharge lines from oil wells, it is not described or suggested the stimulation of oil reservoirs.

A further example of systems of this type is disclosed in U.S. Pat. No. 4,475,596. In said patent, there is disclosed a method for increasing the oil extraction from an underground reservoir comprising a borehole and a gas generator, which is in the borehole at or above the reservoir level. The gas generator includes a housing forming a chamber and having an inlet at the upper end for receiving a fuel; a catalyst assembly in the upper region of the chamber; a gas generation reaction chamber under the catalyst assembly. Said reaction chamber has a chemical reactant inlet and a lower outlet for the passage of gaseous reaction products, which are at high temperature.

Said method comprises the stepwise operation of the gas generator: letting a fuel flow from the surface consisting of hydrogen peroxide; catalytically reacting the hydrogen peroxide to form hot reaction gases including oxygen and steam; and causing the hot reaction gases to contact a chemical reactant which converts oxygen into vapor, whereby the hot reaction products (oxygen-free) are injected into the oil reservoir.

The above mentioned system has the disadvantage that the catalytic reactions are carried out inside the borehole, by means of a surface injection system, making it impossible to control said reaction inside the borehole.

In the field exploitation with low recovery and high viscosity, the use of artificial systems of production is very common, being the most popular in the world the Mechanical Pumping, where the equipment often loses efficiency or stops operating due to the precipitation of heavy components, as asphaltenes, paraffins or solids, in the suction of bottom pump.

This condition can lead to efficiency loss of the oil displacement by the pump, operation stoppage by siltation and in the worst case, the complete stoppage of the artificial system due to system failure, all this resulting in production loss of the well and additional expenses, due to the intervention of completion equipment and well repair.

In the market, currently there are different systems to diminish these problems, in which we find the chemical methods like the injection of viscosity reducers, circulations with organic components (aromine) or the diesel circulation; there are also conventional thermal means such as hot oil injection, as well as conventional steam injection generated with water.

The hot oil circulation entails safety risks during the operation and 100% rigging cleaning is not guaranteed, since temperatures like those of the steam are not reached, so that when returning to its original temperature, it can even get worse the problem of clogging inside the well.

The use of steam for rigging cleaning in oil production wells is a 100% effective practice for cleaning, not only the rigging but also the face of the interval, removing the heavy ones on the face of the formation; however, conventional steam systems can not carry out these practices, since they only serve in wells with thermal rigging, limiting their application only to those who have these arrangements making their application uncostly for cleaning by means of steam cyclic injection, known as “Huff and Puff”.

The application of the system for generating superheated steam of the present invention, regarding the application of the conventional systems for the continuous steam injection, present differences that allow to obtain an advantage in the quality of the injected steam and in the condition of gas phase of the steam itself, additional to innovation in the way of generating steam.

On the other hand, transport lines, discharge ducts, artificial production systems and production intervals are the main elements where there are obstructions of paraffins, asphaltenes and heavy components of hydrocarbons, due to the change in the thermal and pressure conditions once output the well production. In these elements, it is common to find a pressure decrease of about 30% along the lines and decrease in the line diameter, which results in increases in the back pressure in the head of the wells, which causes a decrease of the contribution in the well production. Also, the corrosive materials accumulation in the pipes generates problems of recurrent leakages in relatively short periods of time.

To solve this problem, in the prior art, chemical methods have traditionally been used to remove such obstructions, which not always are completely efficient for the total removal of accumulations of heavy hydrocarbon components, which is in addition to the problem generated by contaminate the oil with these chemicals, reducing its selling price in the market in which it can be marketed.

The cleaning by means of the steam injection is an efficient method that guarantees the complete cleaning of the lines, eliminating the above mentioned phenomena of pressure reduction and corrosive agent accumulation.

On the other hand, throughout the production pipelines, during its operation, heavy components accumulate as the pressure and temperature conditions change, which causes modifications in the hydrocarbon mixture and gas liberation, doing more difficult the phase mobility at a homogeneous speed. The heavy components usually accumulate in bathymetry variations, swings and other changes in direction and depth of the duct, causing obstructions in the ducts, which are reflected in an increase of the back pressure, reducing the production volumes.

In the prior art, there are also chemical methods for cleaning and removal of the obstructions in the ducts, which causes problems during separation, and damage to the elastomeric coatings, as well as corrosion of the equipment in the separation battery.

There are also mechanical methods for the cleaning of ducts, such as devil races (cleaning devices), which represent risks during the operation and the possibility that these cleaning devices be stuck in a high obstruction area. It should be noted that these methods are only applicable for the cleaning of discharge lines.

The use of high pressure and high temperature steam, generated with the system for generating superheated steam using hydrogen peroxide of the present invention, allows to guarantee an effective cleaning of the duct, therefore, since it does not contain any corrosive component in the effluent, does not cause problems of corrosion or damage in pipes and components of the production facilities.

### OBJECTS OF THE INVENTION

An object of the present invention is to provide a system for generating superheated steam using hydrogen peroxide, that allows the superheated steam generation with a higher caloric energy content, at a higher pressure and at a higher temperature than any other prior art steam system.

Another object of the present invention is to provide a system for generating superheated steam using hydrogen peroxide, that allows the pressure and temperature of the steam to be controlled, based on an intervention design that is performed for each oil facility, which will be subjected to cleaning and/or stimulation, always keeping safe the elastomers that may be present in the system.

A further object of the present invention is to provide a system for generating superheated steam using hydrogen peroxide at a concentration from 30% to 70% by weight, that allows the steam generation by means of an exothermic reaction, without the need to remove the stabilizers contained in said hydrogen peroxide.

A further object of the present invention is to provide a system for generating superheated steam using hydrogen peroxide, that allows the steam to be generated at the surface and without the use of water.

A further object of the present invention is to provide a system for generating superheated steam using hydrogen peroxide, that allows handling a high range of volumetric, pressure, and temperature rates, to suit the requirements of each well or oil facility.

A further object of the present invention is to provide a system for generating superheated steam using hydrogen peroxide, which does not require special facilities for its application, in addition to being easy to transport and install.

A further object of the present invention is to provide a system for generating superheated steam using hydrogen peroxide, which requires a shorter application time for the stimulation of the production wells.

Another object of the present invention is to provide a system for generating superheated steam using hydrogen peroxide, that allows to promote production increases in oil wells by stimulating the reservoir and removing formation damages.

A further object of the present invention is to provide a system for generating superheated steam using hydrogen peroxide, that allows to solve problems of low permeability, low porosity, and low pressure in oil reservoirs.

A further object of the present invention is to provide a system for generating superheated steam using hydrogen peroxide, that can act as an enhanced oil recovery (EOR) system, for the secondary oil recovery.

A further object of the present invention is to provide a system for generating superheated steam using hydrogen peroxide that can be applied for cleaning surface oil facilities either onshore or offshore oil facilities, due to its versatility, mobility, and low consumption of products for steam generation.

Another object of the present invention is to provide a system for generating superheated steam using hydrogen peroxide, that allows to obtain a higher productivity of the production wells in regard to other chemical treatments (flow improvers) or mechanical (mechanical inductions) that only work at well level.

An object of the present invention is to provide a system for generating superheated steam using hydrogen peroxide, that can be used in the steam cyclic injection process known as “Huff and Puff”.

Another further object of the present invention is to provide a system for generating superheated steam using hydrogen peroxide, that allows to obtain superheated steam at temperature between 80° C. (176° F.) and 400° C. (752° F.).

A further object of the present invention is to provide a system for generating superheated steam using hydrogen peroxide, which allows the superheated steam to maintain its vapor phase (gas) condition at temperature below 80° C. (176° F.).

Another further object of the present invention is to provide a system for generating superheated steam using hydrogen peroxide, which allows obtaining steam that is not affected by thermal shocks.

A further object of the present invention is to provide a system for generating superheated steam using hydrogen peroxide, which by means of thermal transmission allows the gas trapped in the formation to be released by increasing the reservoir pressure, thereby helping to push the oil to the interval producer, obtaining consequently increases in oil production.

Another further object of the present invention is to provide a system for generating superheated steam using hydrogen peroxide, that allows to clean and stimulate a production well without the need to remove the rod string and the bottom pump, so that can be cyclically cleaned several wells per day without special adjustments.

Another further object of the present invention is to provide a system for generating superheated steam using hydrogen peroxide, that allows the cleaning and removal of solids in production wells of mechanical pumping, and simple flowing by the heat transmission through the entire production rigging.

A further object of the present invention is to provide a system for generating superheated steam using hydrogen peroxide, which can be applied to any type of well mechanics (BN, Cavities, BM, Flowing, Thermals) as well as wells that do not have casing.

A further object of the present invention is to provide a system for generating superheated steam using hydrogen peroxide, that can be applied to any type of geology of the production reservoir.

Another further object of the present invention is to provide a system for generating superheated steam using hydrogen peroxide, which allows that cleaning of wells and surface facilities and equipment; whether onshore or offshore facilities, is carried out in a very short time, without the need to close the facilities for long periods.

Another further object of the present invention is to provide a system for generating superheated steam using hydrogen peroxide, which does not use water or gas for the steam generation process, so it does not harm the environment.

A further object of the present invention is to provide a system for generating superheated steam using hydrogen peroxide, that can be applied in wells with vertical ends, but also in wells with horizontal drilling, being a system that achieves to move in vapor form on the horizontal.

A further object of the present invention is to provide a system for generating superheated steam using hydrogen peroxide, which can return in its vapor condition to the surface, thus traversing the entire recovery system.

### BRIEF DESCRIPTION OF THE INVENTION

The present invention relates to a system for generating superheated steam using hydrogen peroxide, comprising an exothermic reaction derived from combining a hydrogen peroxide solution in different concentrations ranging from 30% to 70% by weight, with different reactive components, preferably potassium permanganate and/or manganese dioxide. The reaction produced with these reactants generates a catalyst during the run out of the reaction, which in turn allows obtain superheated steam at temperatures ranging from 80° C. (176° F.) to 400° C. (752° F.), depending on the conditions which are required to operate.

The system for generating superheated steam using hydrogen peroxide of the present invention is primarily comprised of a steam generator reaction tank, into which a mixture of reactive components is pre-loaded, which when reacted with hydrogen peroxide generate a set of catalysts, so that as the reaction runs out, the superheated steam is generated.

The system for generating superheated steam using hydrogen peroxide of the present invention is conformed of a hydrogen peroxide storage tank, wherein the peroxide solution to be used during the reaction is stored; a discharge pump which is interconnected to the storage tank by a first interconnection duct, the discharge pump being used to pump the hydrogen peroxide solution to a steam generating reaction tank via a second interconnection duct by means of an injection system; a steam generating reaction tank which receives the hydrogen peroxide solution to carry out the steam generation reaction with the compounds or reactants which are pre-loaded therein, where the reaction is carried out and generates the superheated steam, which once generated is sent through an outlet duct to the oil facility which will undergo cleaning and/or stimulation treatment.

### BRIEF DESCRIPTION OF THE DRAWINGS

The configuration and elements of the system for generating superheated steam using hydrogen peroxide can be seen in the following indicated figures, wherein a particularly preferred embodiment of the invention is shown, which is to be considered as illustrative only, but not limiting thereof, wherein:

FIG. 1 is a schematic view showing how the elements forming the system for generating superheated steam using hydrogen peroxide of the present invention are interconnected.

FIG. 2 is a general diagram showing the elements forming the system of the present invention

FIG. 3 shows the behavior of well 1 before being intervened.

FIG. 4 is a graph showing the production history of well 1 before and after treatment with the system for generating superheated steam of the present invention.

FIGS. 5 and 6 show the behavior of the well 2.

FIG. 7 shows the behavior of the well 2 before being intervened.

FIG. 8 shows the behavior of the well 2 after being intervened with the system for generating superheated steam of the present invention.

FIG. 9 is a graph showing the production history and production increase of the well 2 after being intervened with the system for generating superheated steam of the present invention.

### DETAILED DESCRIPTION OF THE INVENTION

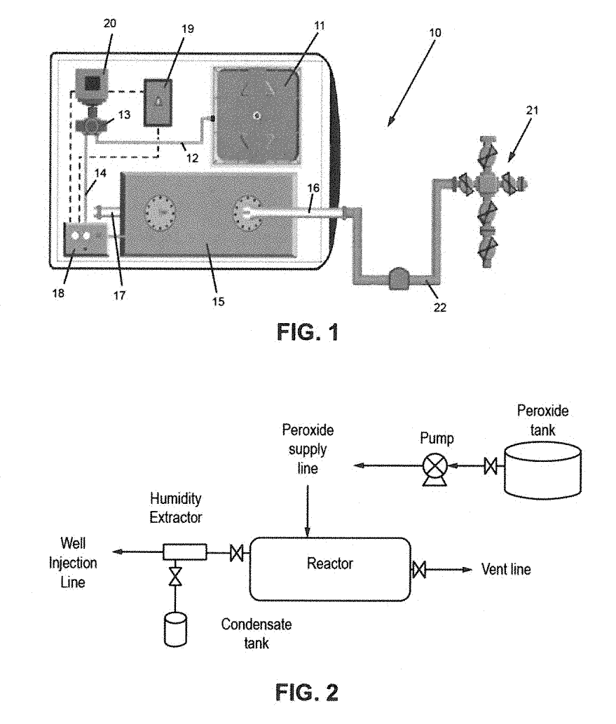

Referring now to the accompanying drawing, and more specifically to FIG. 1, there is shown the system for generating superheated steam 10 using hydrogen peroxide of the present invention.

The system for generating superheated steam 10 is conformed of a hydrogen peroxide storage container 11, preferably a tank, wherein the peroxide solution to be used during the reaction is stored; a hydrogen peroxide discharge pump 13 which is interconnected to the storage container 11 by a first interconnection duct 12, the discharge pump 13 being used to pump the hydrogen peroxide solution to a reaction container 15 by a second interconnection duct 14; a steam generating reaction container 15, preferably a reaction tank or reactor, which receives the hydrogen peroxide solution to effect the reaction with a plurality of compounds or reactants which are previously loaded into a reaction chamber, wherein the reaction is carried out and the superheated steam is generated, which once generated exits through an outlet nozzle to be sent by the outlet duct 16 to the facilities 21 to be cleaned, preferably oil installations. The reaction container 15 further has a venting nozzle to which a duct 17 is interconnected to allow the exhaust of gases during the reaction or in emergency event.

To perform the interconnection between the system for generating superheated steam 10 and the installations 21 to be cleaned, at least one interconnection duct 22 is used.

The system for generating superheated steam 10 further has a control panel 18, which is interconnected to a peroxide injection system 19, for regulating the supply flow of peroxide solution to the reaction tank 15; and to the motor 20 of the discharge pump 13 to operate and stop the pump in case of emergency (emergency stop). Also, the control panel 10 has at least one pair of temperature and pressure indicators.

To facilitate the transfer of the system for generating superheated steam 10 to the site where the steam cleaning procedure is carried out, its components are fixed on a platform or structural skid to be incorporated into a trailer.

The system for generating superheated steam of the present invention, due to its structural characteristics, is a compact and portable system which for its field operation only requires a crew of two to three persons, and can be easily transportable in an automotive vehicle (Platform or pick-up truck) with a capacity of at least 1.5 tons, or on a trailer of at least 3000 kg (6613 lbs.).

The hydrogen peroxide solution required for the superheated steam generation is stored in the storage container 11 in a concentration ranging from 30% to 70% by weight, it being possible to use plastic materials such as IBC totes, with capacity of at least 1000 liters with a 2-inch valve and metal base for peroxide of up to 50% concentration, or stainless steel containers, depending on the peroxide concentration.

The discharge pump 13 in a preferred embodiment is designed to operate at a discharge pressure of up to 9,000 psi pressure, not to be limited to these operating and design conditions, since different capacities may be used, depending on the design of the intervention and the required steam volumetry.

The discharge pump motor 13 may be an internal combustion engine which uses gasoline or diesel, or it may be an electric motor using alternating current or direct current, which may be powered by a battery pack or may be connected to the local electricity distribution network.

The steam generating reaction container 15 contains therein as already mentioned a plurality or set of reactants which react with the hydrogen peroxide to carry out the exothermic reaction necessary for the gaseous effluents production. The set of reactants are contained as blocks within a reaction chamber (not shown in the figure). The reactant blocks have a useful life of up to 10 interventions or 15 continuous operation hours, whichever comes first.

The steam generating reaction container 15 has an outlet nozzle to which the outlet duct 16 is interconnected (preferably using a hose), further including a shutoff and opening valve (preferably using a ball valve); and, a venting nozzle which interconnects a vent valve to the atmosphere. In a further embodiment, the venting nozzle includes a locking valve.

The first interconnecting duct 12 may be a flexible tubing or hose designed to operate at low pressure; while the second interconnection duct 14 and the outlet duct 16 may be a flexible tubing or hose designed to operate at high pressure (up to 15000 psi).

In a preferred embodiment, the duct 14 may be a high-pressure rubber and/or stainless steel hose, while the duct 16 may be a hose of polymeric materials for extreme pressure with 2-inches rubber or neoprene cover, or 2-inches high-pressure 1502 carbon steel pipe.

The duct 22 which is interconnected to the outlet duct 16 to supply the superheated steam to the oil facility to be subjected to a cleaning and/or stimulation process may be a flexible hose which in a preferred embodiment is a metal hose with rubber coating, designed to withstand up to 5,000 psi, of a dimension appropriate to the volumetric rate to be supplied, preferably 2 inches.

The connection type used to interconnect the system for generating superheated steam with the oil facility to be subjected to the cleaning and/or stimulation procedure are fast connections to allow a fast, easy, practical, and safe interconnection.

Once all the elements have been interconnected and the system for generating superheated steam using hydrogen peroxide has been put into operation, the operating, pressure and/or rate conditions of each element are verified before the injection inside the well is made; once the intervention is performed, the characteristic parameters of each element are re-measured and a constant monitoring of the operating conditions is performed, once it occur a significant decrease in the efficiency of the system that impacts on production volumes, the injection is performed again and cyclically repeated to maintain optimum operating ranges.

In the reaction chamber of the steam generating reaction container 15, the exothermic reactions which generate the gaseous effluents are carried out (superheated steam) required for the cleaning and/or stimulation preferably of oil installations.

In a preferred embodiment, three reactants are mainly used in the reaction chamber:
Hydrogen peroxide (H₂O₂) between 30% and 70% by weight;
Potassium permanganate (KMnO₄) as catalyst precursor; and,
Sucrose (C₁₂H₂₂O₁₁) known as common sugar, as organic fuel.

Hydrogen peroxide, at high concentrations, is a very corrosive substance, that when contacted with organic fuels can initiate a heat generating chemical reaction (exothermic reaction).

It has unexpectedly and surprisingly been found that hydrogen peroxide, once reacted with potassium permanganate to form manganese dioxide, which in turn functions as a reaction catalyst, if contacted with an organic fuel, such as sucrose or common sugar, reacts violently generating steam and pure oxygen at elevated temperature, which can reach up to 400° C. depending on the conditions and quantities of reactants used.

Potassium permanganate is a dark purple solid reactant, which has the property of oxidizing and decomposing the hydrogen peroxide when small amounts of this reactant are used.

In the chemical industry, potassium permanganate is considered a very strong oxidant, so that from the chemical reaction with hydrogen peroxide are obtained (in addition to heat for being an exothermic reaction), as reaction products the following: steam, oxygen, magnesium dioxide residues and traces of potassium hydroxide.

Considering the foregoing, the inventors of the present invention unexpectedly found from experimental work in the laboratory and pilot plant that the addition of organic fuels, such as sucrose (common sugar), yields reaction temperatures greater than those of prior art.

The chemical reactions that occur when the sucrose is incorporated in the reaction are fundamentally the following:

2KMnO₄₍ₛ₎+3H₂O_{2(ac)}→2KOH₍ₛ₎+2MnO₂₍ₛ₎+2H₂O_{(g)}+30_{2(g)} (I)

16KMnO₄₍ₛ₎+C₁₂H₂₂O₁₁₍ₛ₎→8K₂CO₃₍ₛ₎+MnO₂₍ₛ₎+4CO_{2(g)}+11H₂O_{(g)} (II)

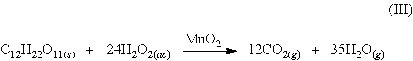

As will be appreciated, the chemical reaction occurring in the system for generating superheated steam using hydrogen peroxide of the present invention, consists essentially of reacting hydrogen peroxide with granulated potassium permanganate in the presence of a combustible substance, preferably sucrose: The required amounts of each compound are calculated stoichiometrically and depending on the application that will be given to the system.

Initially, the reaction mixture is prepared from the solid reactants of potassium permanganate (KMnO₄) and sucrose (C₁₂H₂₂O₁₁), using water as the solvent to form the solid blocks which are to be introduced into the reaction container and subsequently reacted with the hydrogen peroxide and generate the catalysts. Once the reaction has started, the blocks go from a solid state to a liquid state (aqueous).

As can be seen from the reaction scheme, hydrogen peroxide (H₂O_{2(ac)}) reacts with potassium permanganate (KMnO₄) to produce carbon dioxide (MnO₂), which in turn functions as a catalyst in the reaction (III) wherein the combustible substance reacts with the released oxygen causing a violent reaction generating mainly steam at a very high temperature. This is because the combustible substance can generate an exothermic reaction when combined with the released oxygen, produced from the decomposition reaction of the peroxide in the presence of MnO₂. The released oxygen is considered atomic rather than molecular, since it is first separated from the hydrogen peroxide. Therefore, oxygen is even more susceptible to combination with the combustible substance.

The different catalysts used for the catalytic decomposition of hydrogen peroxide are the following: manganese oxide IV or manganese dioxide (MnO₂), iron oxide III (Fe₂O₃), calcium oxide (CaO), lead oxide (PbO₂), calcium oxide (Ca(OH)₂). Other catalysts used are aluminum oxide (Al₂O₃), copper oxide II (CuO), copper oxide III (Cu₂O), potassium chromate (K₂CrO₄), potassium dichromate (K₂Cr₂O₇), the transition metal compounds also used for peroxide decomposition are the following: K₂CrO₄, KMnO₄, CuSO₄, among others.

It is important to note that the formed potassium hydroxide (KOH) is an inorganic salt whose dissolution in water generates heat (strongly exothermic reaction), so that a strong reaction can occur when the potassium hydroxide is added to the water, helping therefore to increase the temperature in the system.

The KOH is a salt and its ions are dissociated in water in the following form:

H₂O+KOH→K+, OH—, H₂

In the system for generating superheated steam of the present invention, an aqueous solution of hydrogen peroxide is used between 30% and 70% by weight. The water present in this solution does not participate in the reactions; however, it absorbs the energy produced from these reactions by changing from liquid state to steam.

It can be seen in reaction (II) that a part of the sucrose (C₁₂H₂₂O₁₁) reacts with the potassium permanganate (KMnO₄) producing manganese dioxide (MnO₂), carbon dioxide (CO₂) and steam.

The three reactions together produce the following gaseous effluents: CO₂, O₂ and H₂O; so, once the sucrose (C₁₂H₂₂O₁₁) and the potassium permanganate (KMnO₄) have been consumed the only reaction that occurs in the reaction chamber is only and exclusively the hydrogen peroxide decomposition in the presence of the catalyst, manganese dioxide (MnO₂) that is to say:

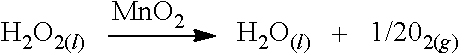

In this decomposition reaction (IV) influences factors such as pressure, temperature, and reactant concentration, but also must consider the presence or not of a catalyst, which, as already mentioned for this reaction, the manganese dioxide (MnO₂) performs this function.

Manganese dioxide (MnO₂), is a mineral that under normal conditions is gray metallic. It usually is formed by the manganese deposition in sediments or by the oxidation of other manganese and iron minerals, such as quartz or limonite.

This decomposition reaction theoretically produces a steam mass composition of about 76.5% by weight and oxygen of 23.5% by weight.

The decomposition of the hydrogen peroxide by itself does not create the desired temperatures. A 50% aqueous solution of hydrogen peroxide in contact with the permanganate will raise the temperature in the reaction tank. However, with the addition of the combustible substance from organic origin, preferably sucrose, unexpectedly it has been found the conditions given in Table 1.

The operation of the temperature scale (from 80° C. to 400° C.) will depend on the design that is made for the intervention based on the characteristics of the same, therefore the variable operating temperature (operating window) will depend on the concentration of the hydrogen peroxide solution to be used in conjunction with the catalysts and the back pressures to which the reaction container is subjected.

On the other hand, as organic fuels can also be used gasoline and/or coal dust, among other common fuels.

In Table I, the conditions achievable with the system of the present invention are shown:

TABLE 1

| Parameter | Minimum | Maximum | Observations |
|---|---|---|---|
| Temperature | 80 | 180 | Peroxide from 30 to 50% |
| (° C.) | | | concentration |
| Temperature | 80 | 400 | Peroxide from 50 to 70% |
| (° C.) | | | concentration |
| Pressure | 0 | 3000 | Pressure regulated by |
| (psi) | | | injection valve |

Notes
The back pressures to which the system is subjected, either by manual throttling to accelerate the effluent speed (vapor) or automatic to counter the external back pressures, or for solid buffers present in the facilities to be treated (wells and/or surface installations); act directly on the working pressure generated by the reactor.
The temperature (scale between 80° C. and 400° C.) will depend on the concentration of hydrogen peroxide used, according to the intervention design that is generated for each installation to be treated, depending on the maximum and minimum temperature conditions that its components support, mainly the elastomers present in pumps.

To overcome the drawbacks of the prior art, a system for generating superheated steam has been designed, using hydrogen peroxide and a set of reactants which produce an exothermic reaction. It is very important to mention that during the reaction, catalysts are generated that decompose hydrogen peroxide into superheated steam at temperatures ranging from 80° C. (17° F.) to 400° C. (752° F.).

Depending on the conditions with which it is required to operate, the reaction allows to obtain a vapor with a higher injection temperature (superheated steam) and a better quality in the steam (100% without water drops in suspension) than any other known system in the prior art, with a negligible oxygen concentration.

The steam obtained with the present invention is used for the injection into oil fields or for cleaning petroleum installations such as pipelines, heads, discharge lines, separation batteries, coolers, production wells, heat exchangers, tanks, refineries, coke treatments, fluid mobility, etc.

It should be noted that only superheated steam is injected, because the system of the present invention is designed to in no way inject hydrogen peroxide into the well and/or pipe, to avoid that could affect the chemical nature of the crude, as well as the nature of the equipment and/or facilities, since a balanced reaction is carried out inside the reactor thus obtaining a conversion of 100% hydrogen peroxide into superheated steam. Within the reaction chamber of the reactor, the reactant quantities, the hydrogen peroxide flow, and the design thereof have been optimized to ensure the highest efficiency in reaction with the sole aim of avoiding, at its maximum expression, gaseous effluents containing reactants. In addition, it is important to note that the temperature within the reaction chamber of the reactor, allows the self-accelerated decomposition of the hydrogen peroxide.

The system of the present invention is fully portable and of instantaneous steam generation, which allows to move the system to any remote installation, besides not requiring special adaptations for its interconnection, nor water is required for the steam generation, nor ignition gas to generate steam. The latter is one of the major advantages of the present invention in safety aspects, since the oil installations are operated without explosion risk, since no fire is required for the heating.

Even more prominent is the fact that by applying the system for generating superheated steam of the present invention, no expense is required to adapt the wells and/or facilities, thus providing a practical, economic, and functional system, which has advantages over any other prior art system.

Once the stimulation procedure has been applied with the system of the present invention, the production increasing effects in the well are immediately visible upon completion of the procedure, and may even be visible while the steam injection is performed (from 1 to 2 hours), reaching its production peak approximately in one month, stabilizing and obtaining its reorder point, being able to maintain it with 1 to 2 monthly cycles until exhausting the reserves.

The process consists of three main phases: injection, soaking and production. The injection phase basically consists in injecting a certain amount of 100% quality superheated steam into the reservoir at a predetermined pressure and temperature rate, for one or several hours, depending on the characteristics of the producing formation and the well conditions.

At the end of the injection, the well is closed for 1 day soaking period to allow the steam to warm and permeate the producing formation (reservoir) and spread evenly around the well. Subsequently it opens to production until the production curve falls and the intervention is required again, period that has on average 2 interventions per month.

A well can undergo several injection cycles, minimum 2 every 15 days, which will depend on the mechanical conditions of the well and the production. The increase rate of production at 24 hours, which has been observed with this system, has been superior to 30% in wells of high productivity, as well as increases in low productivity formations of more than 100%, these increases depend on own factors of the formation, crude type, recovery system type, °API of the oil, among other technical characteristics present in the wells to be treated. Additionally, the technology of this invention is applicable to any type of reservoir geology, continuous and discontinuous sands, limestones, naturally fractured limestones, etc.; so, there is no need for complex studies or numerical simulation of reservoirs for their application.

In the case of surface installation cleaning, the results are immediate once the treatment with superheated steam is finished, further reducing the operating costs minimizing the stop times of the installations, as for example the cleaning of a heat exchanger in a refinery.

The cyclic superheated steam injection using the system of the present invention is an improved recovery method consisting of injecting superheated steam into the reservoir for a short period; once the steam is injected, the well is closed so that the steam transfers its heat energy to the reservoir; and finally, the well is open to production. The cycle is repeated until the well is no longer profitable.

The steam injection allows reducing the viscosity of the oil inside the reservoir to improve the mobility of the same and to allow its displacement towards the production system, as well as to remove the paraffins, asphaltenes and solids present, that generate blockages in the systems.

The present system for generating superheated steam using hydrogen peroxide, in addition to the reservoir stimulation, can also be used for cleaning the rigging used during mechanical pumping, thus improving the operating conditions of the mechanical pumping system and improving the supply of fluid from the well, by cleaning the face of the producer intervals (downhole system where the oil enters to go up the surface), these small slots lose effectiveness when they are covered and therefore avoid the oil output, greatly reducing well production.

Also, with the intervention of the system of the present invention, the natural ability of the well to produce oil is restored.

It is very important to mention that conventional steam does not work in horizontal wells for its “hot water in the bottom” condition; however, the superheated steam system of the present invention operates horizontally, since it never loses its gaseous phase condition, allowing the intervention of wells in which horizontal fractures and multi-fractures have been carried out, as well as in wells of the new techniques of “fracking”.

The application of the system for generating superheated steam using hydrogen peroxide, compared to conventional methods in the application of the “Huff and Puff” methodology of steam injection, has no comparison in time, efficiency, and cost, in addition to the conventional technology for cleaning production wells, requires thermal wells for the lengthy injection for at least 28 days.

| Characteristic | Conventional boiler | Superheated steam |
|---|---|---|
| Injection Time | 28 to 40 continuous | 30 minutes to 3 |
| | days | hours |
| Closing time | 30 days | 1 day |
| Incremental | 6 to 7 months | 3 weeks to 3 months |
| production time | | |
| Special thermal | Is required | Not required |
| wells | | |
| Use of fossil fuel | Is required | Not required |
| Use of treated | Is required | Not required |
| water | | |
| Special connections | Is required | Not required |
| and thermal | | |
| insulation | | |

### Application Principle

The removal of solids in oil wells with superheated steam is given under the principle of heat transfer, by increasing the temperature of the hydrocarbon components they reduce their viscosity, increasing their mobility, and are removed, releasing the obstructed space, and allowing the free passage of fluids. On the other hand, in the stimulation of reservoirs, the same principle is considered, since when obtaining a temperature increase, not only the damage is removed near the well, but also the viscosity of the oil is reduced, allowing greater fluid supply from the formation to the well, thus increasing the production of hydrocarbons and making any oil project more profitable.

Carrying out the cleaning and/or stimulation, it is guaranteed the flow certainty in the integral production system obtaining a greater profitability. Also, the application of thermal technology helps significantly to solve the problems of formation damages, of interfacial phenomena type, such as: emulsion blockage that occurs when a viscous emulsion occupies the pore space near the well blocking the flow, decreasing the productivity rate, or alteration of the wettability or permeability, which occurs when the precipitation of asphaltenes in the porous media, alters the permeability of the formation, the rock is wetted by the petroleum, reducing the relative permeability of this, which hinders its movement in the porous media.

The temperature increase is the most efficient method for the cleaning and removal of heavy hydrocarbon components, by reducing the viscosity of the oil, which allows its movement through the production rigging.

The versatility of the system for generating superheated steam using hydrogen peroxide allows a higher injection temperature and a better quality of the obtained steam than any other known system of prior art, which allows to reach a greater depth, obtain temperature differentials greater than those existing in the well and consequently a greater effectiveness in the rigging cleaning.

Other advantages of the use of superheated steam from hydrogen peroxide is that steam is generated without water droplets in suspension, no emission of greenhouse gases is generated from the burning of fossil fuels, no waste contaminants is generated, no fire hazards, the crude is not contaminated, nor the pipes are corroded.

On the other hand, when the system of the present invention is used for the rigging cleaning, the main parameter to be evaluated is the comparison of the expected operating conditions, current operating conditions, operating conditions during the test, and final operating conditions; however, the most representative parameter to be measured that indicates if the rig and well cleaning are effective, is the percentage of effort in the rods.

The procedure for rigging cleaning is as follows:

a) Consider the design of the mechanical pumping rigging:
Mechanical condition and production history.
Operation of the well in ideal conditions.
Potential to increase production.
Volumetry of the steam to be injected.
Obstructions along the rigging.
Where the steam injection will be made (TP production pipe or TR casing).

b) Analysis of historical dynamometric charts.

c) Analysis of dynamometric charts prior to the intervention.

d) Analysis of dynamometric charts during the intervention.

e) Analysis of dynamometric charts after the intervention.

f) Optimization of mechanical pumping.

These considerations result in a document called Design Bases, which specifies all the requirements that can be considered for the operation; in the case of wells with obstruction of paraffin in the production pipe (TP) are considered three modalities of intervention:

a) direct injection by TP.—This case is considered when a partial obstruction of the TP has been identified, as operating margin is considered in the case of having resistance in the pumping, re-pressuring the TP with superheated steam injection up to 500 psi.

b) Injection by casing (TR).—This case is considered when a total obstruction has been identified in the TP, the operation consists of injecting superheated steam through the TR until re-pressuring the same to 500 psi, closing the well and giving waiting time of approximately 2 hours for the heat to be transmitted to the PT by removing the obstruction by means of the heating of the solids housed in the TP.

c) Steam injection into wells without production pipe by connection on the side.

The fundamental aspects to be evaluated are the correct operation of the mechanical pumping system and the benefit in production increments that can be obtained when using the system of the present invention.

The application of the system of the present invention, has as purpose to guarantee the flow certainty through the integral production system, removing obstructions, optimizing facilities, and guaranteeing the correct operation of the different types of production rigging.

It is important to mention that the system of the present invention employs an innovative technology for the superheated steam generation using hydrogen peroxide, so that the heat transmission in a homogeneous steam flow (superheated steam), allows remove reservoirs of paraffins, asphaltenes, heavy oil and solids, reservoirs that obstruct the fluid flow, causing a malfunction of the production rigging, or even render some integral production system components inoperable.

The operation principle is based on the thermal energy transmission at very high temperature (superheated steam) and with a 100% quality of steam, which when in contact with the reservoirs of heavy components of crude, reduces its viscosity and makes them highly fluid, so they are removed and allow the free passage of fluids and the correct functioning of the integral production system components.

The system of the present invention may be employed for:

1. Well stimulation.—By means of the thermal energy transmission in the porous medium, the fluid flow in the reservoir increases, obtaining very significant improvements in well productivity and oil recovery, improving profitability and lengthening the life of the reservoirs, significantly increasing oil production.

2. Cleaning of the vicinity of the well and face of the intervals.—The greatest impact or damage by drilling fluids and fracture fluids occurs in the area surrounding the well known as the “vicinity of the well”. In this area is the biggest change in the flow conditions in the reservoir, so it is also the area where changing the pressure and temperature conditions, the oil tends to precipitate paraffins and asphaltenes which obstruct the entry of fluids into the well. With the system of the present invention, carrying out the superheated steam injection it is transmitted thermal energy, which removes the damage near the well and the producing interval, eliminating the obstruction by paraffins and asphaltenes; in this way cleaned flow channels are obtained that allow the contribution of fluids to the well and consequently a greater uptake of production.

3. Cleaning of rigging.—In the case of mature fields handling heavy oils or low productivity, the use of artificial production systems is essential. Due to the production fluid conditions, mechanical conditions of the system, the presence of heavy components derived from the oil and/or in combination with solids from the fractured formation, obstructions are formed, which do not allow the proper functioning of the artificial system or they leave it inoperative. By means of superheated steam circulations with the system of the present invention, all solids causing the above-mentioned problem are removed, leaving the rigging in optimum operating conditions, offering the benefit of not only cleaning the system components, but also all the pipes of the well and the face of the intervals.

4. Discharge lines and transport ducts cleaning. —Along the production pipes and the transport pipelines, there are various conditions for the layout of the line, such as reduction or enlargement of diameters, changes of trajectory and/or bathymetry; as well as exposure to environmental temperatures, which influence the shear stresses and temperature changes during the layout, conditions favoring the precipitation of paraffins and asphaltenes. On the other hand, by the same characteristics of the production fluid, when exposed to conditions below its bubble point, large amounts of gas are lost, so that the fluid is modified in its behavior, reducing the viscosity, and generating high backpressures in the complete integral production system. With cleaning by the system of the present invention the obstructions are removed, leaving available the total flow area of the pipe for the free passage of the production fluids, thus reducing the system backpressures. When there is the presence of extra-heavy oils of very low viscosity, points of continuous injection can be determined along the duct, thus guaranteeing a reduction in viscosity throughout its trajectory, which makes it an integral system of flow certainty.

5. Facility Cleaning.—The various production riggings are also susceptible to malfunction or disabling due to the presence of heavy, paraffin and solids. With the system of the present invention, when using superheated steam, it is possible to carry out the cleaning of equipment and accessories, without having to disassemble them or subject them to major maintenance involving their removal or disassembly.

However, the system operating philosophy of the present invention considerer strictly complying with environmental safety and protection standards at national and international level, so that the highest environmental safety and protection standards are always fulfilled.

The process for the operation and application of the system of the present invention in well is as follows:

1).—Verification of facilities in field (site visit and determination of access route).

2).—Preparations prior to the intervention (check supplies, tools, safety equipment and signage necessary to perform the intervention, conditions, and equipment functionality).

3).—Transfer of equipment to the site of the intervention.

4).—Location of equipment and verification of installation conditions.

5).—Meeting with the staff to establish the work program and review the safety plan of the facility (emergency response plan).

6).—Equipment installation (See FIG. 2).—The intervention activities are initiated and the necessary interconnections are made (production pipes that are not involved are isolated from the line(s) that are being intervened.

7).—Meeting of Start of Operation to assign responsibilities and detail the steps to follow.

8).—Preheating of the system.

9).—Cleaning of the rigging:
a).—The injection is made by the production pipe (TP) or by the casing (TR) as the case may be, until the pressure determined in the previous design of the intervention is reached, once said pressure is reached, it is closes the well and a settling time of approximately 2 hours is given, the pressure in TP is monitored and the opening of the well is carried out verifying the outlet of fluids.
b).—The rigging cleaning is performed by opening the TR valve for the superheated steam injection, the TP valve is kept open and the TP pressure is monitored at the outlet until the return of fluid with steam is observed. Once this condition is reached, the well can circulate for a period of 5 min to ensure the removal of any heavy components from the rigging.

10).—Well induction:
a).—Once the well pressure is depressed, the stimulation treatment thereof is carried out, by injecting superheated steam with the system of the present invention according to the design conditions. The well is closed by giving time to soak and its production contribution is evaluated.
b).—The outlet valve is closed in TP and the superheated steam injection is started to the formation. The injection time will depend on the analyzed and proposed well conditions. Once the scheduled injection time is reached, the injection valve is closed in TR and the steam pumping is stopped, closing the valves of the head.

11).—Disconnection of equipment.

12).—Removal of equipment.

13).—Well opening.—Once the soak time has elapsed (1 hr. for cleaning and up to 48 hrs. for stimulation), the well is opened and aligns to the production rigging. The results are evaluated verifying the well contribution and operation conditions of the artificial system.

14).—Monitoring and tracing.—The well production is evaluated on a constant basis, with level monitoring in the tank, establishing a limit to perform the treatment again. Once the production declines to a predetermined point, the treatment to restore production is performed again.

Also, the system for generating superheated steam using hydrogen peroxide can be used for the cleaning of discharge lines, oil-gas-ducts, and connections to the collection head. The parameters to be evaluated during the operation, is the back pressure that exists in the discharge line, for which the pressures in the well head and in the connection to the head are measured to determine the pressure differential in the line. Once the cleaning is performed, the pressure differential is remeasured, whereby the effectiveness of the treatment is determined using the steam generation system of the present invention. When cleaning, a waste tank or metal dam is used to contain debris from the pipes because of cleaning, and in this way, it is also possible to determine if there is presence of solids on the discharge line that obstruct the free passage of fluids towards the collection head.

The process for cleaning the discharge lines by the present system for generating superheated steam using hydrogen peroxide is as follows:

1).—Transfer of the equipment to the site of the intervention.

2).—Location of the equipment and verification of the installation conditions.

3.—Meeting with the staff to establish the work program and review the facility security plan (emergency response plan).

4).—Equipment Installation:
a).—Connection of the output of the steam generator to the standpipe of the discharge line.
b).—Connection of the discharge line to the metal dam.

5).—Components verification and installation.

6).—Meeting of start of the operation to confirm assignment of responsibilities and detail the steps to follow.

7).—Preheating of the steam generation system (equipment startup).

8).—Once the pressure, temperature, and vapor saturation conditions have been reached, the injection is started for the cleaning of the line according to the previously calculated volumes for the treatment.

9).—The color characteristics are verified at the exit of the metal dam.

10).—The superheated steam supply is closed and the discharge line is reconnected to the head.

11).—It is verified that the lines are depressurized and disconnection of the equipment is made.

12).—The equipment is disassembled in its entirety and the order and cleaning of the area is verified.

13).—The results are evaluated and it is determined if there are improvements in the flow conditions, as well as reduction of the pressure differential at the inlet and outlet of the line.

The system for generating superheated steam using hydrogen peroxide of the present invention can also be used for the thermal cleaning of measurement ducts in the installation and general production ducts of the same installation. The parameter to be evaluated is the back pressure that exists in the discharge line, so the pressures in the well head and in the connection to the head are measured, to determine the pressure differential in the line. Once the cleaning was made, the pressure differential is remeasured to determine the effectiveness of the treatment.

When cleaning a waste tank or metal dam, it is also possible to determine if there is presence of solids in the discharge line, which obstruct the free passage of fluids to the collection head.

The procedure, to carry out the thermal cleaning of the measuring ducts and the general production ducts in the installation is as follows:

1).—Transfer of the equipment to the intervention site.

2).—Location of the equipment and verification of the installation conditions.

3) Meeting with the staff to establish the work program and review the facility security plan (emergency response plan).

4).—Equipment Installation. Interconnection of the steam generation system to the duct.

5).—Components verification and installation (check list).

6).—Meeting of start of the operation to confirm assignment of responsibilities and detail the steps to follow.

7).—Preheating the steam generation system (equipment start).

8).—Once the pressure, temperature and vapor saturation conditions have been reached, the injection is started for the cleaning of the line according to the calculated volumes for the treatment

7).—Preheating of the steam generation system (equipment startup).

8).—Once the pressure, temperature, and vapor saturation conditions have been reached, the injection is started for the cleaning of the line according to the calculated volumes for the treatment.

9).—The locking valves of the ducts are closed.

10).—The superheated steam supply is closed.

11).—It is verified that the lines are depressurized and disconnection of the equipment is made.

12).—The equipment is disassembled in its entirety and the order and cleaning of the area is verified.

13).—The results are evaluated and it is determined if there are improvements in the flow conditions, as well as reduction of the pressure differential at the inlet and outlet of the line.

However, when the system for generating superheated steam using hydrogen peroxide is used for the stimulation of offshore oil reservoirs, the procedure is as follows:

1).—Well measurement before treatment.

2).—Introduce the system for generating superheated steam directly in the well bed in the form of chambers, which will have the characteristics suitable to conform to the pipe and bottom conditions, so that the reaction is generated directly at the bottom hole, or else the injection can be effected from the surface using flexible tubing.

3).—Depending on the well characteristics, to place in series or not several interconnected equipment, to generate the chain reaction, thus avoiding both the loss of pressure and counteract the thermal shock.

4).—Close the well to give time to soak and that the heat transfer is carry out.

5).—Open the well and monitoring production.

6).—Once the production with the stimulation starting is reached again, repeat the treatment.

Prior to start-up, must be carried out the following:

1).—Verification of facilities in the field (visit to the site and determination of access route).

2).—Preparations before intervention (verification of valve shafts, connections type to be used, safety measures, connection of containment systems).—.

3).—Conditioning of the access route.

4).—In the case of rigging cleaning, it is required open the wells by the casing at least 5 days before the intervention to not have gas repression for the steam injection.

5).—Verification of access path one day before the intervention to prevent setbacks.

The intervention consists of:

1).—Preparations before intervention (verification of supplies, tools, safety equipment and signage necessary to perform the intervention, conditions, and equipment functionality).

2).—Transfer of equipment to the site of the intervention.

3).—Location of the equipment and verification of the installation conditions.

4).—Meeting with the staff to establish the work program and review the facility security plan (emergency response plan).

5).—Photographic evidence is taken of the state of the location, valve shaft, counter-well and equipment, to make the corresponding report.

6).—Equipment Installation.—The required equipment is accommodated, the unit employing the system for generating superheated steam of the present invention is located, 2 meters from the head in front of the well.

7).—The interconnection of the system for generating superheated steam is carried out with the well installations (reservoir) to be stimulated, as well as the metallic dam.

8).—Meeting of start of the operation to confirm assignment of responsibilities and detail the steps to follow.

9).—It is verified that all the valves of the system for generating superheated steam are closed.

10).—The hydrogen peroxide supply to the pump is opened.

11).—The venting of the reaction chamber to the atmosphere is opened.

12).—The hydrogen peroxide pumping to the reaction chamber of the present system is initiated.

13).—The temperature and steam quality at the reaction chamber outlet are verified.

14).—Once the desired temperature is reached, the injection to the well begins.

15).—The pressure is regulated by partially closing the venting, once the desired pressure has been reached, the partial or total closing of venting is maintained.

16).—The pump operation is maintained until the hydrogen peroxide flow is stabilized.

17).—Once the calculated theoretical volume of hydrogen peroxide has been pumped, the pumping stops (pomp stop).

18).—The interconnection of the of system for generating superheated steam with the well installations (reservoir) to be stimulated is closed.

19).—The peroxide supply to the pump is closed.

20).—Any pressure in the system is relieved to generate superheated steam, fully opening the venting.

21).—The disconnection of the system for generating superheated steam with the well installations (reservoir) to be stimulated is carried out.

22).—The disconnection of the line to the metal dam is made.

23).—The interconnection of the standpipe to the production pipe is made.

24).—Equipment is secured and disassembled.

### Examples of Application

The following are three application examples of the system for generating superheated steam using hydrogen peroxide of the present invention, where in the first two was made the cleaning of mechanic pumping riggings and in the third example was carried out a stimulation process.

### Well 1

### Application Principle

The elimination of solids in oil wells using superheated steam is given under the principle of heat transfer. As the temperature of the hydrocarbon compounds increases, they reduce their viscosity and increase their mobility, so they are removed releasing the clogged space and allowing the free passage of fluids. On the other hand, in the stimulation of reservoirs, the same principle of increase in the temperature of the hydrocarbons generated by superheated steam is considered, allowing not only the removal of the damage near the well, but also the reduction of viscosity of the oil allowing greater contribution of fluid from the formation to the well, thus increasing the hydrocarbons production and making more profitable any oil project.

When performing the cleaning and/or stimulation of the well, it is guaranteed the flow assurance in the integral production system, obtaining a greater profitability in any petroleum project.

### Objective

Derived from the high presence of paraffin found in Well 1, it was proposed to perform the cleaning of the pneumatic pumping rigging, using the steam injection in the rigging, which steam was obtained by the system for generating superheated steam using hydrogen peroxide of the present invention, thereby the operating conditions of the artificial pneumatic pumping system and the supply of fluid from the well was improved.

### Background

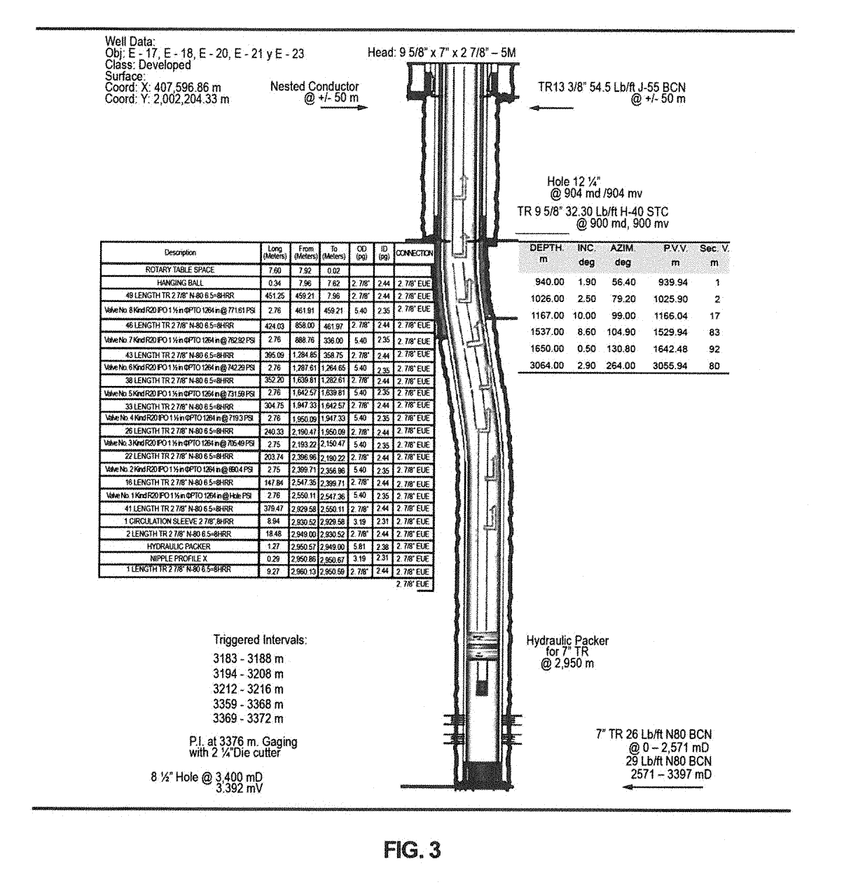

In FIG. 3 and in the following table, the measurements made to the Sánchez Magallanes 2019 well prior to the intervention are shown. The well had a flow (Qo) of 87.6 barrels per day (BPD).

### Evaluation Criteria

For the cleaning of the rigging, the following evaluation points were defined:

1. EQUIPMENT EFFICIENCY: Considering transport, installation, versatility, operating time.

2. OPERATION OF PNEUMATIC PUMPING RIGGING: The correct opening and closing of each and every one of the valves of the rigging is considered.

3. PRODUCTION EVALUATION: The comparison between the measurement before operation and the after the same is considered.

4. OBSERVATION OF FLUID RETURN TO METALLIC DAM: Samples of the returned fluids are taken, as well as measurement of the same.

### Development of Activities

The activities performed are shown.

### Hour Operation

10:30-11:30 Arrival of operative staff. The permission to work in the well is filled.
11:30-1:30 System connections to the casing (TR) are made and from the metal dam to production pipe outlet(TP) based on the recommendations of the facility security personnel. Lines are tested, no leakage is detected in lines and valves of vent to dam.
14:00-14:45 It starts with the ignition of the steam generation system, with initial pressure in TP of 7 kg/cm². Steam is injected through the annular space at 150 psi pressure and an average temperature of 110° C. The injection is performed for 45 min, detecting a pressure increase in the system up to 300 psi. The injection of vapor is cut to initiate the heat exchange towards the rigging.
14:00-15:15 Time is given for the heat exchange for the cleaning of the rigging.
15:15-16:30 The well was operated with pneumatic pumping aligned to the dam, recovering 3 m³ of paraffin
16:30-17:00 The paraffin is recovered from the metal dam, by a tank truck sent by the operations personnel. The disconnection of the equipment is performed, the location is verified applying order and cleaning. The equipment is removed.

### Results

### Equipment Efficiency—Successful

a. The transportation was carried out without any 5 inconvenience due to the physical characteristics and design of the equipment

b. As for the installation, it was done in a time of 2.5 hours. Here, an opportunity area was found that could be improved using high pressure flexible hoses and high temperature for the connections at floor level.

c. The equipment operating time was 45 min, injecting a volume of 35 m³ at well conditions, at average pressure of 150 psi and an average temperature of 230° F. (110° C.).

d. Return of paraffins was observed in metal dam and samples were taken.

### Operation of Pneumatic Pumping Rigging—Successful:

e. Regard to operation of the rigging BN post-operation, the staff in charge of the well operated the rigging checking the correct opening and closing of the 7 pump-out valves, leaving the well operating with the orifice valve, providing production fluid.

### Production Evaluation—Successful:

f. The measurement of the well after the intervention is shown:

The well showed a flow (Qo) of 119,760 barrels per day (BPD).

FIG. 4 shows the graph where the production history of well 1 before and after treatment with the system for generating superheated steam of the present invention can be observed.

### Final Comments

Because of the cleaning of the production rigging with BN of the well, it was observed that the cleaning was successful in observing the return of paraffin housed in TP.
When operating the BN, the correct opening and closing of all rigging valves was observed; staying operating with low pressure in the BN network of 30 kg/cm² to 15 kg/cm² observing oil supply aligned to battery.
There is an increase of 36.71% in the daily well production.
The use of flexible hoses for high pressure and high temperature is recommended to minimize leakage points, installation times and logistics.

The safety requirements requested by the operator to carry out the activity were fulfilled; Abiding at all times the observations made by the security personnel.

### Well 2

### Objective

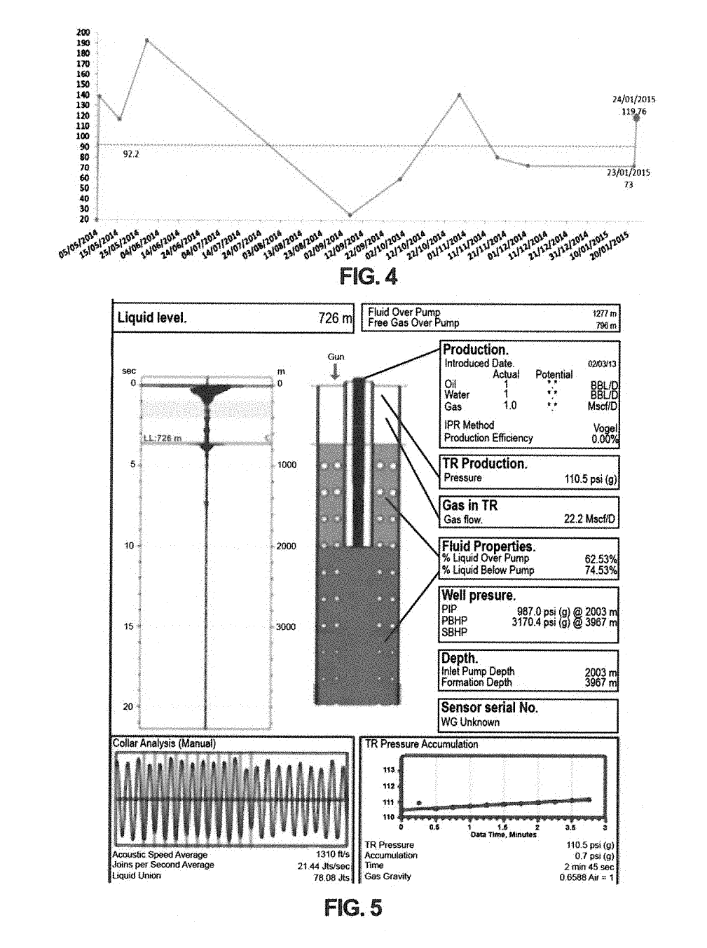

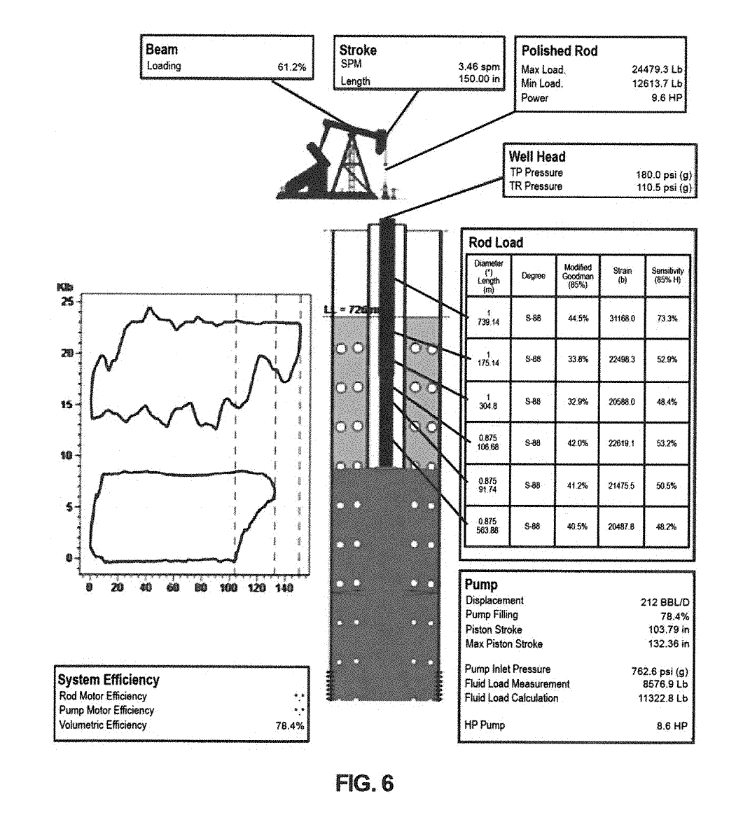

Perform the thermal cleaning with the injection of superheated steam generated by hydrogen peroxide in well 2, improving the operation conditions of the artificial mechanical pumping system and improving the supply of fluid from the well. The behavior of the well 2 is shown in FIGS. 5 and 6.

### Evaluation Criteria

For the accomplishment of this intervention, the following points for the evaluation were defined:

1. EQUIPMENT EFFICIENCY: Considering transport, installation, versatility, operating time.

2. EFFICIENCY OF MECHANICAL PUMPING RIGGING: The reduction of load in the UBM and the optimum operation of the system is considered.

3. PRODUCTION EVALUATION: The comparison between the previous measurement to the operation and the subsequent is considered.

Development of Activities:

The activities performed are shown.

### Hour Operation

14:00-15:00 Aligned to metal dam, the well is vented from 100 psi in TR at 0 psi.
15:00-15:40 With the well aligned to the metallic dam, is effected the superheated steam injection by annular space with 250 psi of pressure and a temperature ranging from 230° F. (110° C.) to 284° F. (140° C.) in injection line and increase in temperature in the TP line (return) from 40 to 92° C., the injection is performed for 35 min. Where it is observed steam outlet along with oil to metal dam. Total volume of injected steam 175 m³ at surface conditions.
16:00-17:00 UBM is put into operation to evacuate fluids aligned to metal dam, observing return of oil and paraffins, samples are taken. Operative personnel align well to production, disconnection of the equipment is carried out, suction of fluids of metallic dam is made, the location applying order and cleaning is verified. Equipment from the location is removed.

### Results

### Equipment Efficiency—Successful:

a. The transportation was done without any inconvenience due to the physical characteristics and the equipment design.

b. As for the installation, was carried out in a time of 3 hrs. Here, an opportunity area was found that could be improved using high pressure and high temperature flexible hoses for the connections at floor level.

c. The operating time of the equipment was 35 min, injecting a volume of 52.5 m to well conditions, at average pressure of 150 psi and average temperature of 248 OF (120° C.).

d. Steam circulation was observed with paraffins return with production fluids in metallic dam without the need to operate the UBM.

### Efficiency of Mechanical Pumping Rigging—Successful:

About the efficiency of the BM, it was verified with the dynamometric chart, Observing a great improvement in the efficiency of the mechanical pumping, better filling of the pump and increased production.

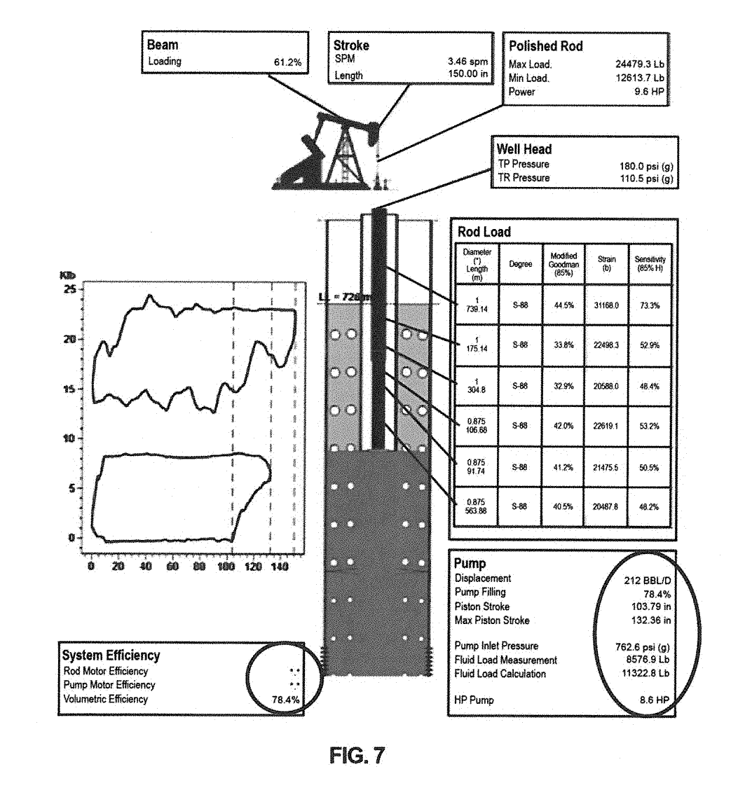

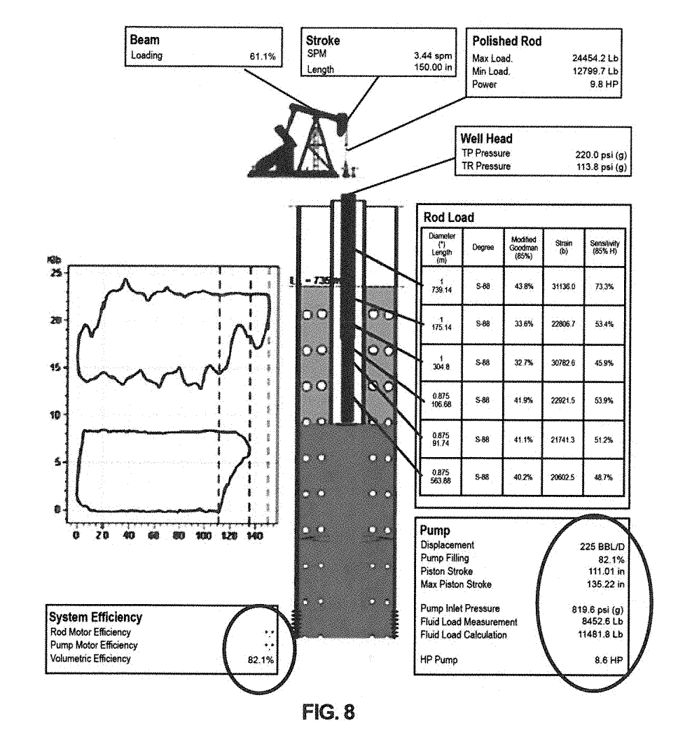

FIG. 7 shows the behavior of the well before the intervention and FIG. 8 is shown the behavior of the well after the intervention.

### Production Evaluation

The measurement of the well after the intervention is shown obtaining 36 barrels per day (BPD) of incremental production.

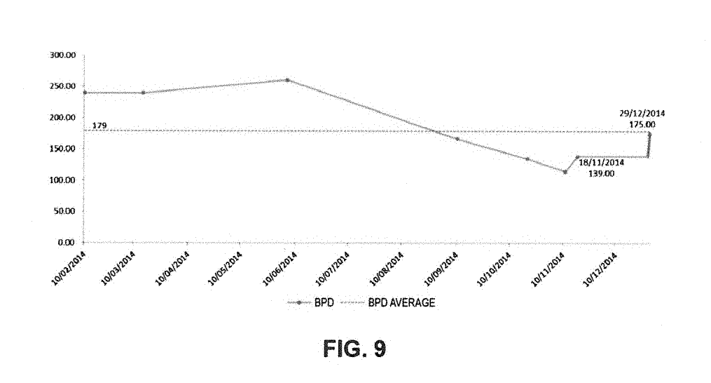

FIG. 9 shows the production history and production increment graph after the intervention.

### Remarks and Comments

Because of cleaning of production rigging of BM of the well, the following is observed:
Complete steam circulation was observed, according to program.
Personnel of measurement company mentioned that qualitatively observed improvement in the operation of the UBM motor.
Return of solids and paraffins was observed in both metallic dam and samples taken, confirming the removal of material housed inside the TP

An echocardiogram and dynamometric chart will be made for comparison of before and after treatment.

### Well 3

### Objective

To increase the production of the treated well, removing damages in the formation and improving the fluid mobility with the injection of superheated steam generated by hydrogen peroxide; also, improving the operating conditions of the artificial mechanic pumping system and improving the supply of fluid from the well.

### Background

The Odessa-Midland area is in South Texas and contains reservoirs of sands interspersed with crude oil types that mostly range from heavy to extra heavy type, the fields have 90% secondary recovery systems being the mechanical pumping type the prevailing in the wells.

### Scope

Increase production in oil wells by stimulation by means of superheated steam.
Evaluate the technology impact on cleaning times and removal of solids in well components.
Evaluate the technology scope in terms of intervention time, hydrogen peroxide rate and reactants.
Validate the procedures and evaluation criteria of each intervention in oil wells.
Verify the general operating conditions of oil wells in the area.
Test the technology in progressive cavity wells.

### Well Characteristics

### Well 1:

Depth: 350 meters.

### Arrangement: TR and TP.

Bottom pressure: 20 lbs.
Head pressure: 50 lbs.

### Pump Type: Progressive Cavity.

Average Production: 1 barrel per day.

### Well 2:

Depth: 600 meters.

### Arrangement: TR and TP.

Bottom pressure: 25 lbs.
Head pressure: 100 lbs.

### Pump Type: Mechanical Pump Mark II.

Average Production: 1.5 barrel per day

It was observed that in the well 1 had very low pressure, which indicates obstructions by precipitation of paraffins, the use of emulsion-breaking chemicals to control these precipitations was observed, the crude extracted from the well is extra heavy, is operating in the Well a progressive cavity pump by the density of the crude and the handling of solids that the well contains, it is important to emphasize that it is the first time that a steam system is applied in wells of these characteristics.

In well 2 were observed paraffin precipitations and the use of emulsion-breaking chemicals to control such precipitations, the well was operating with a mechanical pump Mark II, which only operates about 1 hour daily, heavy crude is observed, this well was subjected to a “fracking” process, increasing its production to 40 barrels per day the same that fell for one month to its current production of 1.5 barrels per day.

### Intervention with Superheated Vapor System in Well 1 (Progressive Cavity)

The following operating parameters were determined:
Intervention time: 30 minutes
Maximum operating temperature: 140° C.
Maximum operating pressure: 150 psi.
Connection of the system by TR (casing) leaving TP open (production pipe) always.

Because the type of pump in this well has an elastomer that can be susceptible to damage by high temperatures, and considering that a thermal stimulation or cleaning medium has never been used in this type of pumps, it was proceed to intervene the well with additional supervision measures, monitoring at all times the behavior of the pump and leaving it to operate to avoid accumulation of pressure or temperature in the pump, at the end, the intervention time in the well was of 17 minutes with the following results:
The steam injection was made by TR, the complete circulation of the well it took only 5 minutes observing superheated steam outlet of by TP.
The paraffin output was observed once it was circulated in a well for 2 more minutes and then oil with a lower density.

### Results:

The production of the well increased by 10 barrels per day, the pump never stopped operating.

### Intervention with Superheated Steam System in Well 2 (Mechanical Pumping)

The following operating parameters were determined for well 2:
Intervention time: 1 hour
Maximum operating temperature: 180° C.
Maximum operating pressure: 200 psi.
Connection of the system for generating superheated steam by TR (casing) leaving TP (production pipe) open for 15 minutes to clean the production rigging and the remainder closing TP (production pipe) for the stimulation of the formation.

The intervention time was 1 hour with the following results:
Injection of steam by TR it took in completely circulate the well, 7 minutes having steam outlet by TP.
The paraffin output was observed once it was circulated in a well for 10 minutes more and then oil with a lower density.
TP was closed after 17 minutes to give opportunity to vaporize the formation, pressure increases in the head and continuous circulation of steam each time the TP valve was opened for verification.
Once completed the intervention, TP and TR were closed to give a soak time of 18 hours.
The next day TR was opened and depressurized, TP was then opened and the pump was shaken as it contained gas, the pumping started with 100 pounds of pressure in the head and 200 pounds in the operation of the pump.

### Results

Production of the well increased by 30 barrels per day.
Production of crystalline water was observed in the well, as result of fracture water residues from a previous intervention.

While a preferred embodiment of the present invention has been described and shown in the foregoing description, it should be emphasized that numerous modifications are possible thereto, without departing from the true spirit of the invention, such as modifying the elements forming the present system, as well as their disposition and interrelation. Thus, the present invention should not be restricted except as required by the prior art and the appended claims.

1. A system for generating superheated steam using hydrogen peroxide comprising a hydrogen peroxide storage container, wherein a peroxide solution is stored which is used during the reaction to generate the superheated steam; a hydrogen peroxide discharge pump which is interconnected to the storage container by a first interconnection duct, the discharge pump being used to pump the hydrogen peroxide solution into a reaction container by a second interconnection duct; a steam generator reaction container or reactor wherein the reaction is carried out and the superheated steam is generated, which receives the hydrogen peroxide solution for the reaction to take place and the superheated steam is generated, to be sent through a nozzle and an outlet duct, to the facilities that will be subjected to cleaning and/or stimulation.

2. The system for generating superheated steam using hydrogen peroxide of claim 1, wherein the reaction container or reactor includes a reaction chamber therein, wherein a plurality of reactants is placed, which are pre-loaded prior to initiating the reaction with the hydrogen peroxide; as well as a nozzle and a venting duct, to allow the gases to escape during the reaction, or in case of emergency.

3. The system for generating superheated steam using hydrogen peroxide of claim 1, wherein for the interconnection between the system for generating superheated steam and the installations which will be subjected to cleaning and/or stimulation, at least one interconnection duct is used.

4. The system for generating superheated steam using hydrogen peroxide of claim 1, wherein the system for generating superheated steam further has a control panel which is interconnected to a system of peroxide injection to regulate the supply flow of peroxide solution to the reaction container, as well as to the discharge pump motor to operate and/or stop the pump in case of emergency; in addition to having at least a couple of temperature and pressure indicators.

5. The system for generating superheated steam using hydrogen peroxide of claim 1, wherein to facilitate the transfer of the system for generating superheated steam to the site where the cleaning and/or stimulation procedure will be performed, its components are fixed on a platform or structural skid, being by its dimensions a compact and portable system, that for its transfer requires an automotive vehicle whose capacity is at least 1.5 tons or a trailer whose capacity is at least of 3 tons.

6. The system for generating superheated steam using hydrogen peroxide of claim 1, wherein the hydrogen peroxide solution required for the superheated steam generation is stored in the storage container in a concentration ranging from 30% to 70% by weight.

7. The system for generating superheated steam using hydrogen peroxide of claim 2, wherein the plurality of compounds or reactants which react with the hydrogen peroxide are contained as blocks within the reaction chamber and have a lifespan of up to 10 interventions or 15 continuous hours of operation, whichever occurs first.

8. The system for generating superheated steam using hydrogen peroxide of claim 7, wherein in the reaction chamber, three reactants are used: hydrogen peroxide (H₂O₂) in the range of 30% to 70% % by weigh; and, a block of potassium permanganate (KMnO₄) as catalyst precursor and sucrose (C₁₂H₂₂O₁₁) as organic fuel.

9. The system for generating superheated steam using hydrogen peroxide of claim 8, wherein the hydrogen peroxide reacts with the potassium permanganate to form the manganese dioxide, which functions as catalyst of the reaction, by continuing the reaction and contacting the sucrose, a violent reaction occurs which generates steam and pure oxygen at elevated temperature, which can reach up to 400° C. (752° F.), depending on the conditions and quantities of reactants used.

10. The system for generating superheated steam using hydrogen peroxide of claim 9, wherein compounds selected from: manganese oxide IV or manganese dioxide (MnO₂), iron oxide II (Fe₂O₃), calcium oxide (CaO), lead oxide (PbO₂), calcium hydroxide (Ca(OH)₂, aluminum oxide (Al₂O₃), copper oxide II (CuO), copper oxide II (Cu₂O), potassium chromate (K₂CrO₄), potassium dichromate (K₂Cr₂O₇), copper sulphate (CuSO₄), among others, can also be used as catalysts for the catalytic decomposition of hydrogen peroxide.

11. The system for generating superheated steam using hydrogen peroxide of claim 8, wherein gasoline and/or coal dust can also be used as organic fuel.

12. The system for generating superheated steam using hydrogen peroxide of claim 9, wherein the reaction with the organic fuel allows temperatures ranging from 80° C. to 180° C. to be reached at a concentration of 30% to 50% by weight of hydrogen peroxide and from 80° C. to 400° C. at a concentration from 50% to 70% by weight of hydrogen peroxide, on a pressure scale up to 3000 psi.

13. The system for generating superheated steam using hydrogen peroxide of claim 12, wherein the superheated steam obtained has a steam quality of 100% with no water droplets in suspension and a negligible oxygen concentration, further no emission of greenhouse gases is generated from the burning of fossil fuels, no waste contaminants is generated, no fire hazards, the crude is not contaminated, nor the pipes are corroded

14. The system for generating superheated steam using hydrogen peroxide of claim 13, wherein the superheated steam is used for the injection and/or stimulation of oil fields (wells), as well as for the cleaning of oil installations such as pipelines, heads, discharge lines, separation batteries, coolers, production wells, heat exchangers, tanks, refineries, coke treatments, fluid mobility, etc., achieving arrive by the temperature profile obtained, to a greater depth, by obtaining higher temperature differentials than those existing in the well and consequently a greater effectiveness in the cleaning of riggings and/or process equipment.

15. The system for generating superheated steam using hydrogen peroxide of claim 1, wherein the system is fully portable and of instantaneous steam generation, which allows to move the system to any remote installation, further is not required special adaptations for their interconnection in wells and/or installations, nor water is required for the steam generation or ignition gas to generate steam.

16. The system for generating superheated steam using hydrogen peroxide of claim 15, wherein the system can be applied in horizontal wells, as the superheated steam never loses its gas phase condition, which allows the intervention of wells in which have been carried out fractures and horizontal multi-fractures, as well as the techniques of“fracking”, as well as wells with horizontal terminations

17. The system for generating superheated steam using hydrogen peroxide of claim 14, wherein the application of the system for generating superheated steam during the well stimulation, allows obtaining steam injection times from 30 minutes to 3 hours, well shutdown time of one day and incremental production time from 3 weeks to 3 months.
